(19) United States
(12) Patent Application Publication
(10) Pub. No.: US 2019/0306248 A1
(43) Pub. Date: Oct. 3, 2019

(54) SESSION VERIFICATION USING UPDATED SESSION CHAIN VALUES

(71) Applicant: CA, Inc., New York, NY (US)

(72) Inventors: Muralidhar Swarangi, Hyderabad (IN); Manjunath K B, Meerpert (IN); Anusha Badveeti, Hyderabad (IN)

(21) Appl. No.: 15/943,449

(22) Filed: Apr. 2, 2018

(51) Int. Cl. H04L 29/08; H04L 29/06; H04L 9/08; H04L 9/32

(52) U.S. Cl. CPC H04L 67/14; H04L 63/08; H04L 9/3236; H04L 9/0861; H04L 63/10

(57) ABSTRACT

Techniques are disclosed relating to performing session verification for a session between a client computer system and a server computer system. In some embodiments, a server computer system may perform session verification by initially performing a first session verification operation followed by iterations of a second session verification operation. In some embodiments, a given iteration of the iterations of the second verification operation may include receiving, from the client computer system, client authentication information that includes first and second authentication values. Further, in some embodiments, a given iteration may include determining a server authentication value that is based on the first authentication value and authentication information previously received from the client computer system during session verification. Additionally, the given iteration may include determining whether to verify the session based on whether the server authentication value matches the second authentication value.

### BACKGROUND

### Technical Field

This disclosure relates generally to session security, and more particularly to performing session verification for a session between a client computer system and a server computer system.

### Description of the Related Art

Server systems such as web servers, application servers, etc., may provide various computing resources to an end user. For example, an application server may host software applications accessible to various end users. The server system may limit access to protected resources to only authorized end users through various authentication techniques. For example, prior to establishing a session with a given user, the server system may require the user perform one or more knowledge-based authentication steps (e.g., provide a username and password) or possession-based authentication steps (e.g., provide a one-time passcode sent to the user's email address).

In some instances, however, a session between a user and a server system may still be vulnerable to exploitation by unauthorized users (e.g., through a “man-in-the-middle” attack), even after such authentication steps have been performed. Thus, in various instances, it may be desirable for the server system to ensure that, during the course of a session, the server system is communicating with the authorized user.

### SUMMARY

Techniques are disclosed relating to performing session verification for a session between a client computer system and a server computer system. In some embodiments, a server computer system may perform session verification by initially performing a first session verification operation followed by iterations of a second session verification operation. In some embodiments, a given iteration of the iterations of the second verification operation may include receiving, from the client computer system, client authentication information that includes first and second authentication values. The first authentication value may be specific to the given iteration, and the second authentication value may be computed by the client computer system based on the first authentication value and authentication values previously computed by the client computer system during the session verification. Further, in some embodiments, a given iteration may include determining a server authentication value that is based on the first authentication value and authentication information previously received from the client computer system during session verification. Additionally, the given iteration may include determining whether to verify the session based on whether the server authentication value matches the second authentication value.

### BRIEF DESCRIPTION OF THE DRAWINGS

FIG. 1 is a communication diagram illustrating an example exchange between a server system and a client computer system to verify a session using updated session chain values, according to some embodiments.

FIG. 2 is a block diagram illustrating an example client computer system, according to some embodiments.

FIG. 3 is a block diagram illustrating an example server computer system, according to some embodiments.

FIG. 4 is a flow diagram illustrating an example method for verifying a session using updated session chain values, according to some embodiments.

FIG. 5 is a flow diagram illustrating an example method for verifying a session using updated session chain values, according to some embodiments.

FIG. 6 is a block diagram illustrating an example computer system, according to some embodiments.

### DETAILED DESCRIPTION

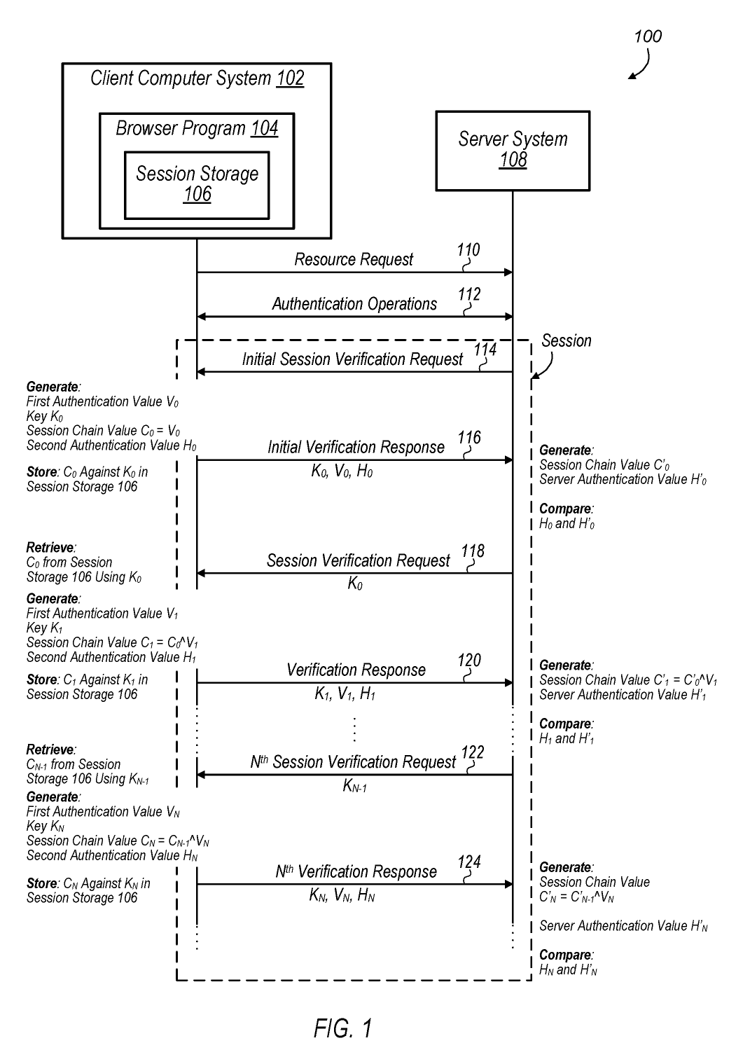

Referring to FIG. 1, a communication diagram 100 illustrating an example exchange for verifying a session between a client computer system 102 and a server system 108 using updated session chain values is depicted, according to some embodiments. Note that, although shown in direct connection, client computer system 102 and server system 108 may be connected via one or more communication networks (not shown for clarity).

In various embodiments, server system 108 may be configured to provide services (e.g., software applications, email services, etc.) to various users, such as a user of client computer system 102. In various instances, server system 108 may limit access to the services it provides only to authorized users (e.g., to protect sensitive data, etc.). A server system may limit access to its services using various user-authentication techniques. For example, a server system may utilize a multi-factor authentication scheme in which a user is required to provide both user credentials and a one-time passcode (“OTP”) delivered to the user via an out-of-band communication (e.g., by email or text message). Once authenticated, the server system and client computer system may exchange various messages as part of a session during which the service is provided to the end user. As used herein, the term “session” is used to refer to a series of communications between a client computer system and a server computer system during a specified time period or while some particular criteria are satisfied. In various embodiments, a session may be demarcated by starting and ending points. For example, in the embodiment depicted in FIG. 1, a session is initiated once the user of client computer system 102 has been authenticated to server system 108, and continues until some event occurs that causes the session to be terminated (e.g., expiration of a timeout period, failure of the user to provide valid session verification information, etc.).

As noted above, however, a session between a user and a server system may be vulnerable to exploitation by unauthorized users, even after the user has been authenticated to the server system. For example, some server systems may provide authenticated end users with data (e.g., an authentication cookie) that the server system may use to identify the end user and maintain the state of the user session. In some instances, however, an unauthorized user may “hijack” a valid session between a user and a server system by obtaining sensitive information (e.g., a cookie) included in messages sent between the client computer system and the server system and use that sensitive information to pose as the authorized user. Further, even in instances in which a secured connection (e.g., HTTPS connection) is used, if there are any intermediate redirects to non-secured sites (e.g., sites using an HTTP connection), then this sensitive information may be subject to compromise by an unauthorized user. Thus, in various instances, it may be desirable for the server system to ensure that, during the course of a session, the server system is communicating with the authorized user, rather than an unauthorized user who has hijacked the session.

In at least some embodiments, the disclosed systems and methods may mitigate these or other shortcomings associated with session security by verifying a session between a client computer system 102 and a server system 108 using updated session chain values. That is, in various embodiments, client computer system 102 and server system 108 may build up a session chain value over iterations of session verification operations between the client computer system 102 and the server system 108, and the session chain value may be used to verify the session. Note that, throughout this disclosure, reference is made to session “chain” values. As used herein, the term “chain” is used to connote that a session chain value is created serially over the course of session verification such that, in various embodiments, an updated session chain value is based on a prior version of the session chain value. For example, in some embodiments, client computer system 102 may generate a session chain value for a given iteration by combining the session chain value from the previous iteration with a randomly generated value.

To protect this session chain value, in various embodiments, the session chain value is not sent between the client computer system 102 and the server system 108. Instead, both client computer system 102 and server system 108 may independently update and maintain their own copy of the session chain value, and may verify the session using authentication information that is generated based on the session chain value. For example, client computer system 102 may then generate an authentication value (e.g., by using a hash function) based on the current session chain value and send that authentication value, along with the randomly generated value, to server system 108. Upon receiving the authentication value and the randomly generated value, server system 108 may update its own, independently maintained session chain value and generate another authentication value (e.g., by using a hash function) based on its session chain value and may compare the two authentication values. If the comparison indicates that the two authentication values are equal, server system 108 may determine that it is still communicating with the authenticated user. If, however, the two authentication values do not compare equally, server system 108 may determine that the session with the authenticated user has been compromised and my take one or more corrective actions (e.g., terminate the session, require the end user to re-authenticate, etc.).

Thus, in various embodiments, the ability of an end user to maintain a session with server system 108 depends on that end user being able to generate valid authentication information, which, in turn, is based on the session chain value. As this session chain value is not sent between the client computer system 102 and the server system 108, however, unauthorized users are not able to intercept this session chain value using a man-in-the-middle attack. Therefore, as explained in greater detail below, various embodiments of the present disclosure allow for increased session security by reducing an unauthorized user's ability to intercept sensitive data and pose as the authorized user.

To explain certain embodiments, session verification is described herein as including a “first,” initial session verification operation, which is then followed by iterations of a “second” session verification operation. For example, exchanges 114 and 116, along with the associated processes performed by client computer system 102 and server system 108, are one example of a first session verification operation, during which a session chain value is initialized and the session verified. Further, exchanges 118 and 120, along with the associated processes performed by client computer system 102 and server system 108, are one example of an iteration of the second session verification operation in which the session is verified using an updated session chain value. The labels “first” and “second” are thus merely used as labels to differentiate between an initial set of operations and iterations of a different set of operations. The terms “first” and “second” are not used, for example to indicate anything else about an ordering of any additional session verification operations that may be performed. For example, reference to a “first session verification operation” followed by iterations of a “second session verification operation” does not preclude that some other session verification operation is performed after the first session verification operation but before iterations of the second session verification operation.

Referring again to the embodiment depicted in FIG. 1, a user of client computer system 102 may attempt to access a service provided by server system 108 by sending a resource request 110. For example, as shown in FIG. 1, client computer system 102 includes browser program 104 with session storage 106. In various embodiments, client computer system 102 may interact with the service provided by server system 108 via browser program 104. For example, the user may send resource request 110 by directing browser program 104 to a website hosted by server system 108.

After receiving resource request 110, client computer system 102 and server system 108 may engage in various authentication operations 112 to authenticate the user of client computer system 102 to server system 108. As one example, server system 108 may implement a multi-factor authentication scheme in which the user is required to provide both valid user credentials (e.g., username and password) and an OTP sent to the user as an out-of-band communication (e.g., via email). Note, however, that this embodiment is provided merely as an example and that any suitable authentication operations 112 may be utilized without departing from the scope the present disclosure.

In various embodiments, server system 108 may send web pages to client computer system 102 with various script elements (e.g., JavaScript elements) that, when executed by browser program 104, cause client computer system 102 to perform various session verification operations. For example, as noted above, server system 108 may initiate a first verification operation by sending, to client computer system 102, initial session verification request 114. In response to this request, browser program 104 may generate a first authentication value V₀ and a key K₀. In some embodiments, first authentication value V₀ and key K₀ may be random values (e.g., integers, alphanumeric values, etc.) generated using any suitable random or pseudo-random functions. In various embodiments, browser program 104 may then generate an initial session chain value C₀ based on the first authentication value V₀. In the depicted embodiment, for example, the initial session chain value C₀ may simply be the first authentication value V₀. Further, browser program 104 may generate a second authentication value H₀ based on the initial session chain value C₀. For example, in some embodiments, the second authentication value H₀ may be a hash value generated based on the initial session chain value C₀ using any suitable hash function (e.g., SHA256). Further, as shown in FIG. 1, browser program 104 may store the initial session chain value C₀ in session storage 106 against key K₀, such that initial session chain value C₀ may later be retrieved using key K₀. Client computer system 102 may then send an initial verification response 116 to server system 108. In the embodiment shown in FIG. 1, initial verification response 116 includes K₀, V₀, and H₀. For example, in one embodiment, K₀, V₀, and H₀ may be included, e.g., as strings, in a HTTP GET request sent from client computer system 102 to server system 108. Note that, in various embodiments, initial verification response 116 does not include the initial session chain value C₀.

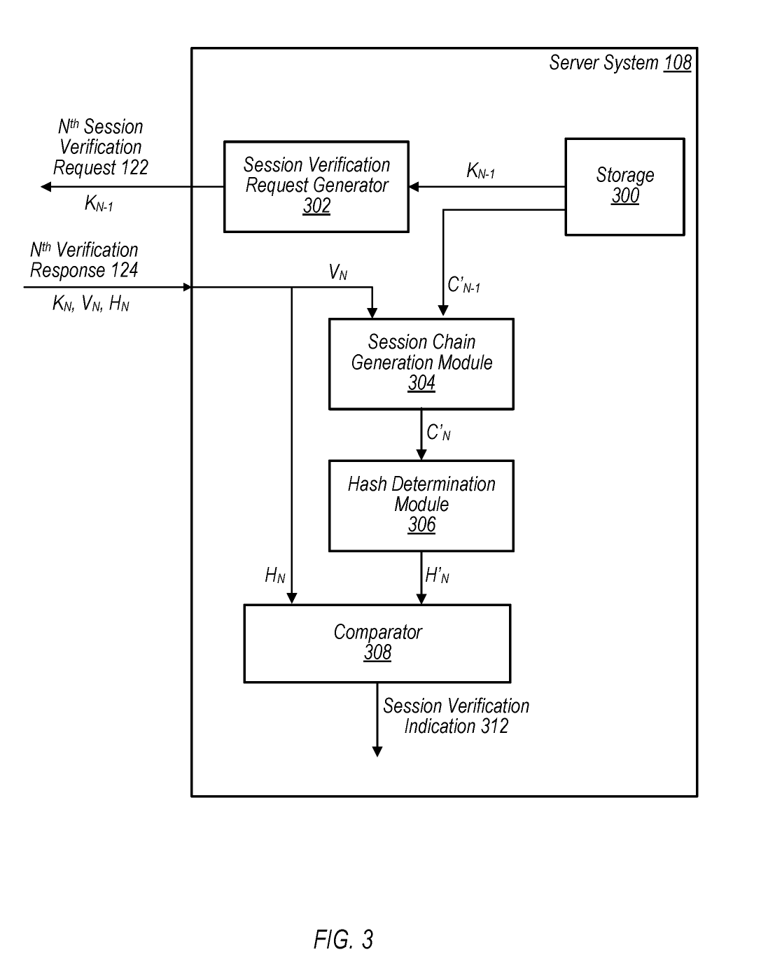

After receiving initial verification response 116, server system 108 may use the information contained therein to generate its own initial session chain value and verify the session with client computer system 102. For example, server system 108 may generate its own initial session chain value C′₀. In some embodiments, initial session chain value C′₀ may be generated based on V₀ received from client computer system 102, as explained in more detail with reference to FIG. 3. Once it has generated session chain value C′₀, server system 108 may generate a server authentication value H′₀ based on session chain value C′₀. For example, in some embodiments, server authentication value H′₀ may be a hash value generated based on initial session chain value C′₀. Note that, while any suitable hash function may be used, in various embodiments the same hash function is used by both browser program 104 to generate second authentication value H₀ and by server system 108 to generate server authentication value H′₀ so that, if the initial session chain value C₀ matches initial session chain value C′₀, second authentication value H₀ will also match server authentication value H′₀. Server system 108 may then compare the second authentication value H₀ and the server authentication value H′₀ to determine whether to verify the session between client computer system 102 and server system 108. If the two authentication values compare equally, server system 108 may determine that it is still communicating with the authenticated user of client computer system 102. If, however, the two authentication values do not compare equally, server system 108 may determine that the session with the authenticated user has been compromised and my take one or more corrective actions (e.g., terminate the session, etc.).

Having performed the first session verification operation, and each creating an initial session chain value, client computer system 102 and server system 108 may perform iterations of a second session verification operation in which the security of the session is repeatedly verified during the course of the session. For example, after a predetermined interval, server system 108 may send a session verification request 118, including key K₀, to client computer system 102. In response to this request, client computer system 102 may generate updated authentication information. For example, browser program 104 may execute various script elements included in the session verification request 118 to generate an updated first authentication value V₁ and updated key K₁, which may be randomly generated values in at least some embodiments. Further, browser program 104 may retrieve initial session chain value C₀ from session storage 106 using key K₀ and generate an updated session chain value C₁ based on the updated first authentication value V₁ and the previous session chain value C₀. For example, in some embodiments, updated session chain value C₁ may be generated by combining the updated first authentication value V₁ and the previous session chain value C₀. In one embodiment, the updated first authentication value V₁ and the previous session chain value C₀ may be combined by performing an exclusive or (“XOR”) operation on the two values. Further, browser program 104 may generate an updated second authentication value H₁ based on the updated session chain value C₁. For example, in some embodiments, updated second authentication value H₁ may be a hash value generated based on updated session chain value C₁.

Client computer system 102 may then send verification response 120 to server system 108. In the embodiment depicted in FIG. 1, verification response 120 includes K₁, V₁, and H₁. Server system 108 may use the information included in verification response 120 to verify the session with client computer system 102. For example, server system 108 may generate its own updated session chain value C′₁. In various embodiments, updated session chain value C′₁ is generated based on the first authentication value V₁ received from the client computer system 102 and the previous session chain value C′₀. For example, updated session chain value C′₁ may be generated by combining the first authentication value V₁ and the previous session chain value C′₀ (e.g., by performing an XOR operation on the two values). Server system 108 may then compare the second authentication value H₁ and the server authentication value H′₁ to determine whether to verify the session between client computer system 102 and server system 108. If the two authentication values compare equally, server system 108 may determine that it is still communicating with the authenticated user of client computer system 102. If, however, the two authentication values do not compare equally, server system 108 may determine that the session with the authenticated user has been compromised and my take one or more corrective actions (e.g., terminate the session).

In at least some embodiments, the iterations of the second session verification operation may be repeatedly performed during the session (e.g., every 10 seconds, 60 seconds, 300 seconds, etc.). For example, as indicated by communication diagram 100 of FIG. 1, iterations of the second session verification operations may be repeated any N number of times during the course of a session, with the operations of a given iteration being similar to those described above in relation to exchanges 118 and 120. For example, during the N^{th} iteration, browser program 104 may generate an updated session chain value C_{N} for that iteration based on a first authentication value V_{N} (generated during the N^{th} iteration) and the session chain value C_{N-1} from the previous iteration of the second session verification operation. Similarly, server system 108 may generate its own updated session chain value C′_{N} based on the first authentication value V_{N} (included in N^{th} verification response 124) and the session chain value C′_{N-1} from the previous iteration of the second session verification operation. In various embodiments, iterations of the second session verification operation may be repeated, at a predetermined interval, for the duration of the session, e.g., until the user voluntarily ends the session or fails to satisfy an iteration of the session verification operations.

The systems and methods of the present disclosure concern technical problems in the field of data security. More specifically, the disclosed systems and methods, in at least some embodiments, address technical problems associated with session security for user sessions between a client computer system and a server system. For example, consider an instance in which an unauthorized user intercepts various messages sent between the client computer system and the server system during the course of a session. In instances in which the server system utilizes static data (e.g., an authentication cookie) to identify the authenticated user, that data may be susceptible to interception by an unauthorized user, who may use that data to pose as the authorized user.

In various embodiments of the present disclosure, however, the disclosed systems and methods may prevent the unauthorized user from hijacking the user session. For example, as noted above, the authentication information used to verify the session is generated based on a session chain value that, instead of being sent across the network, is updated and maintained on each end by the client computer system 102 and server system 108. As the session chain value is not sent across the network, it is therefore less susceptible to discovery through a man-in-the-middle attack. As discussed above, the session verification information used to verify the session (such as the second authentication value H) is dynamic, changing based on the repeatedly updated session chain value C. Therefore, even if an unauthorized user were to intercept any one of the messages (such as verification response 120) sent by client computer system 102 to server system 108, the unauthorized user would be unable to use the information in that message to generate valid session verification information.

For example, assume that an unauthorized user intercepted verification response 120, including K₁, V₁, and H₁, and attempted to use that information to access the service provided by server system 108 by posing as the authorized user. In the event that verification response 120 (from client computer system 102) reached the server system 108 first, then the request sent by the unauthorized user will not be usable to hijack the session. That is, server system 108 will have already generated an updated session chain value C′₁, and an updated server authentication value H′₁ based on C′₁. When server system 108 then receives the request from the unauthorized user and, again, generates an updated session chain value C′₂, and an updated server authentication value H′₂ based on C′₂, the second authentication value H₁ sent by the unauthorized user will not compare equally with H′₂, and the server system 108 may terminate the session. If, instead, the request from the unauthorized user were to reach server system 108 first, the request would still be unable to successfully hijack the session. That is, when the server system 108 then receives the verification response 120 from the client computer system 102, server system 108 will have already generated an updated session chain value C′₁, and an updated server authentication value H′₁ based on C′₁. In response to receiving verification response 120, then, server system 108 will generate an updated session chain value C′₂, and an updated server authentication value H′₂ based on C′₂, and the second authentication value H₁ sent by the client computer system 102 will not compare equally with H′₂, and the server system 108 may terminate the session, require the end user to re-authenticate, or take any other suitable corrective action.

Further, even if the unauthorized user were to intercept every message sent between during session verification, the disclosed methods and systems may include securing the initial session chain value, as discussed below with reference to FIG. 3, such that the unauthorized user would still be unable to successfully generate valid session verification information. Accordingly, in at least some embodiments, the disclosed systems and methods prevent unauthorized users from hijacking user sessions between client computer system 102 and server system 108. Thus, the disclosed systems and methods, in at least some embodiments, improve session security by using updated session chain values, which are not sent across the network, to generate session verification information, improving session security and the functioning of system 100 as a whole.

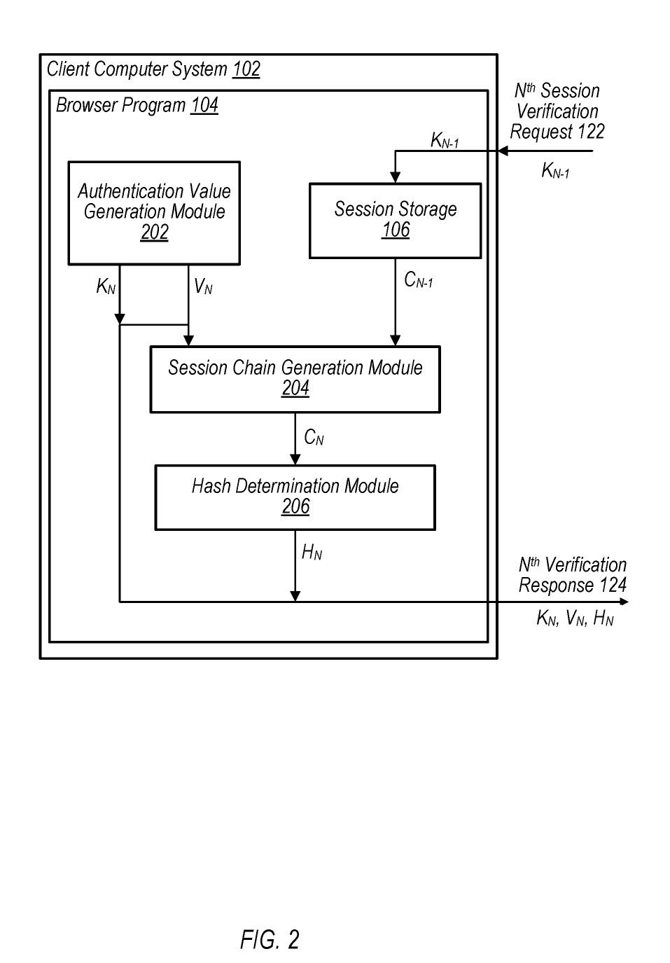

Turning now to FIG. 2, a block diagram illustrating an example client computer system 102 is depicted, according to some embodiments. In various embodiments, client computer system 102 may be operable to perform session verification operations for a session between client computer system 102 and server computer system 108. For example, in the embodiment depicted in FIG. 2, client computer system 102 is shown performing an iteration of the second session verification operation.

As shown in FIG. 2, client computer system 102 includes browser program 104. In various embodiments, browser program 104 is a web browser program, such as Firefox™, Chrome™, Edge™, Safari™, or any other suitable web browser program. For example, in some embodiments, browser program 104 may be an HTML5 compatible web browser. As noted above, in various embodiments, browser program 104 may be operable to execute various script elements contained in web pages sent by server system 108 to perform various session verification operations, such as those described with reference to FIG. 2. For example, in some embodiments, a session verification requests received from server system 108 includes a web page containing various script elements that, when executed by browser program 104, cause client computer system 102 to perform the various session verification operations described herein. Note, however, that this embodiment is provided merely as an example and is not intended to limit the scope of this disclosure. In other embodiments, for example, client computer system 102 may include a software application (e.g., a browser extension or standalone software application) operable to perform the operations discussed in reference to FIG. 2.

In FIG. 2, client computer system 102 receives N^{th} session verification request 122 from server system 108. In some embodiments, server system 108 may send N^{th} session verification request 122 after a particular time interval since the last iteration of the second session verification operation. As shown in FIG. 2, N^{th} session verification request 122 includes key K_{N-1} from the previous iteration of the second session verification operation. In various embodiments, the key included in the session verification requests may be used by client computer system 102 to retrieve authentication information from previous iterations.

In FIG. 2, browser program 104 includes session storage 106, which, in various embodiments, stores information (e.g., on a storage element of client computer system 102) for sessions between client computer system 102 and server system 108 (or other server systems that provide other services). In various embodiments, session storage 106 corresponds to a session storage of browser program 104, which is configured to store data during a particular web session such that when that session has ended (e.g., by terminating browser program 104), the data stored in the session storage is deleted. For example, in at least one embodiment, session storage 106 corresponds to an HTML5 session storage of browser program 104. As discussed in more detail below, browser program 104 may store authentication information, such as keys and session chain values, as session storage object (e.g., as key-value pairs) in session storage 106, in some embodiments, such that a particular session chain value may be retrieved using its corresponding key. In the embodiment depicted in FIG. 2, for example, browser program 104 may use key K_{N-1} to retrieve session chain value C_{N-1} (the session chain value from the N−1^{th} iteration) from session storage 106. Note that session storage 106 is provided merely as an example of a storage component that may be used to store information for use in session verification and is not intended to limit the scope of the present disclosure. In other embodiments, for example, other types of storage components may be utilized instead of, or in addition to, session storage 106, such as a local storage object in a cache of browser program 104.

FIG. 2 further includes authentication value generation module 202, which, in various embodiments, is operable to generate keys K and first authentication values V during the session verification operations (e.g., during the first session verification operation, iterations of the second session verification operation, etc.). For example, in FIG. 2, authentication value generation module 202 generates key K_{N} and first authentication value V_{N} during the N^{th} iteration of the second session verification operations. In various embodiments, the keys K and first authentication values V may be randomly or pseudo-randomly generated values, and authentication value generation module 202 may use a random or pseudo-random function to generate these values. For example, in one embodiment, browser program 104 may use the JavaScript Math.random( ) function to generate the keys K and first authentication values V. In another embodiment, for example, a custom random generator function may be used that is seeded with the time that the iteration of the session verification operation is performed. Note, however, that these embodiments are provided merely as examples and are not intended to limit the scope of the present disclosure. In other embodiments, any other suitable random or pseudo-random function may be used.

FIG. 2 further includes session chain generation module 204, which, in various embodiments, is operable to generate an updated session chain value C based on a first authentication value V and a prior session chain value C from a prior iteration of the session verification. For example, in FIG. 2, session chain generation module 204 generates updated session chain value C_{N} based on session chain value C_{N-1} and first authentication value V_{N}. In various embodiments, session chain value C_{N-1} and first authentication value V_{N} may be combined in any suitable manner by session chain generation module 204 to generate updated session chain value C_{N}. For example, in one embodiment, session chain value C_{N-1} and first authentication value V_{N} may be combined using an XOR operation. In other embodiments, however, any other suitable techniques may be used (e.g., a combination of logical operations). Note that in various embodiments, it may be particularly advantageous to combine session chain value C_{N-1} and first authentication value V_{N} using operations (such as the XOR operation) that do not bias the resulting combination to a particular value after multiple iterations have been performed (e.g., logical AND and OR operations).

FIG. 2 further includes hash determination module 206, which, in various embodiments, is operable to generate a second authentication value H based on an updated session chain value C. For example, in FIG. 2, second authentication value H_{N} is a hash value and hash determination module 206 generates second authentication value H_{N} based on updated session chain value C_{N}. In various embodiments, any suitable hash function may be used, such as SHA-256 or any other suitable hash function.

Once various items of authentication information are generated, client computer system 102 may send a verification response to server system 108, which server system 108 may use to verify the session. For example, in FIG. 2, client computer system 102 sends N^{th} verification response 124 to server system 108, where the N^{th} verification response 124 includes key K_{N}, first authentication value V_{N}, and second authentication value H_{N}. Note that, in the depicted embodiment, N^{th} verification response 124 does not include session chain value C_{N}. As discussed above, the session chain value C is not sent across the network between client computer system 102 and server system 108 in at least some embodiments, which serves to protect the session chain value from discovery by unauthorized users.

As noted above, browser program 104 may store authentication information in session storage 106. In FIG. 2, for example, browser program 104 may store updated session chain value C_{N} in session storage 106 before sending N^{th} verification response 124 to server system 108. For example, in one embodiment, browser program 104 may store updated session chain value C_{N} and key K_{N} in session storage 106 as a key-value pair such that, for a subsequent iteration (e.g., iteration N+1) of the second session verification operation, browser program 104 may retrieve session chain value CN using key K_{N}.

Note that, although FIG. 2 has been described in reference to an N^{th} iteration of the second session verification operation, in various embodiments, client computer system 102 is also operable to perform the first session verification operation. For example, after the user of client computer system 102 is authenticated, server system 108 may send initial session verification request 114 to client computer system 102. Note that, unlike the session verification requests during iterations of the second session verification operation, initial session verification request 114 may not include a key K as there are no prior keys for that user session. In response to receiving initial session verification request 114, client computer system 102 of FIG. 2 may be operable to perform the first session verification operation. For example, authentication value generation module 202 may generate key K₀ and initial first authentication value Vo using any suitable random or pseudo-random function. Further, as there are no prior session chain values on which to base the initial session chain value C₀, the initial first authentication value V₀ may be treated as the initial session chain value C₀, in some embodiments. In such embodiments, hash determination module 206 may generate H₀ by calculating a hash value based on the initial first authentication value V₀. Browser program 104 may then send initial verification response 116, including key K₀, initial first authentication value V₀, and second authentication value H₀, to server system 108. Further note that, as the initial first authentication value V₀ may be sent across the communication network to server system 108, in at least some embodiments, it may be desirable to secure this value, as discussed in more detail with reference to FIG. 3.

Referring now to FIG. 3, a block diagram illustrating an example server system 108 is depicted, according to some embodiments. In various embodiments, server system 108 may be operable to perform session verification, for a session between client computer system 102 and server system 108, using updated session chain values. In the embodiment depicted in FIG. 2, server system 108 is shown performing the N^{th} iteration of the second session verification operation.

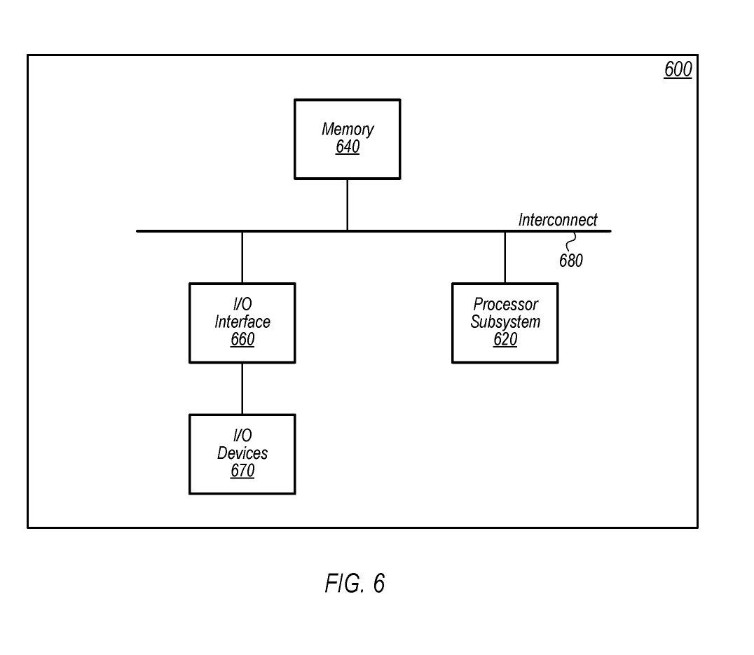

Server system 108 includes storage 300, which, in various embodiments, is a storage element (e.g., memory 640 of FIG. 6, below) configured to store information for a session between client computer system 102 and server system 108. For example, storage 300 may be used to store authentication information, such as keys and session chain values, used to verify sessions between server system 108 and various end users attempting to access the services provided by server system 108. In the embodiment of FIG. 3, for example, keys and session chain values may be stored in storage 300 (e.g., as key-value pairs) such that a session chain value may be retrieved using its corresponding key.

Server system 108 of FIG. 2 includes session verification request generator 302, which, in various embodiments, is configured to generate session verification requests to send to client computer system 102. In some embodiments, the session verification requests sent to client computer system 102 may include a key, either from the first session verification operation or a previous iteration of the second session verification operation, that the client computer system 102 may use to retrieve prior session chain values (e.g., session chain value C_{N-1}, as described above) for use in session verification. For example, in the depicted embodiment, session verification request generator 302 generates N^{th} session verification request 122 that includes key K_{N-1}, the key from the previous iteration of the second session verification operation.

As shown in FIG. 3, server system 108 receives N^{th} verification response 124 from client computer system 102 in response to N^{th} session verification request 122. In the depicted embodiment, N^{th} verification response 124 includes key K_{N}, first authentication value V_{N}, and second authentication value H_{N}, which may be generated by client computer system 102 as described above with reference to FIG. 2.

Server system 108 includes session chain generation module 304, which, in various embodiments, is operable to generate an updated session chain value C′ based on a first authentication value V received from client computer system 102 and a prior session chain value C′ from a prior iteration of the session verification. For example, in FIG. 3, session chain generation module 304 generates updated session chain value C′_{N} based on the first authentication value V_{N}, included in N^{th} verification response 124, and prior session chain value C′_{N-1} from the prior iteration of the second session verification operation. In various embodiments, session chain value C′_{N-1} and first authentication value V_{N} may be combined in any suitable manner by session chain generation module 304 to generate updated session chain value C′_{N}. For example, in one embodiment, session chain value C′_{N-1} and first authentication value V_{N} may be combined using an XOR operation. In other embodiments, however, any other suitable techniques may be used (e.g., a combination of logical operations).

Server system 108 further includes hash determination module 306, which, in various embodiments, is operable to generate a server authentication value H′ based on an updated session chain value C′. For example, in FIG. 3, server authentication value H′_{N} is a hash value, and hash determination module 306 generates the server authentication value H′_{N} based on updated session chain value C′_{N}. In various embodiments, any suitable hash function (e.g., SHA-256) may be used. Note, however, that in various embodiments the same hash function is used by both hash determination module 306 of server system 108 to generate server authentication value H′_{N} and hash determination module 206 of client computer system 102 to generate server authentication value H_{N}.

Server system 108 further includes comparator 308, which, in various embodiments, is operable to compare second authentication value H_{N}, from client computer system 102, with the server authentication value H′_{N}, generated by server system 108, and generate session verification indication 312. In various embodiments, session verification indication 312 may be expressed as a Boolean value, numeric value, or in any other suitable format that specifies the outcome of the comparison performed by comparator 308. Session verification indication 312 may, in various embodiments, be used to determine whether to continue or to terminate the session between server system 108 and client computer system 102. For example, in response to the second authentication value H_{N} matching server authentication value H′_{N}, session verification indication 312 may indicate that the session is verified for that iteration. If, however, second authentication value H_{N} does not match server authentication value H′_{N}, session verification indication 312 may indicate that the session is not verified for that iteration, and server system 108 may take one or more corrective actions, such as terminating the session and requiring the end user to re-authenticate.

Although FIG. 3 has been described in reference to an N^{th} iteration of the second session verification operation, in various embodiments, server system 108 is also operable to perform the first session verification operations. For example, in some embodiments, once the user of client computer system 102 has been authenticated and a session established, server system 108 may initially perform the first session verification operations. For example, session verification request generator 302 may generate an initial session verification request 114 to send to client computer system 102. In this embodiment, initial session verification request 114 may not include a key K, as initial session verification request 114 is the first session verification request sent for that session and there are no prior keys or session chain values for client computer system 102 to retrieve. In response to initial session verification request 114, server system 108 may receive initial verification response 116, including K₀, V₀, and H₀, which server system 108 may use to verify the session.

Note that, during the first session verification operation, there is no prior session chain value on which to base an “updated” session chain value, in various embodiments. Thus, in various embodiments, the initial session chain value C′₀ generated by the server system 108 may be based the initial first authentication value V₀ that is received from the client computer system 102. However, as the initial first authentication value V₀ is sent over a communication network, it may be desirable to secure this value. As discussed below, the initial first authentication value V₀ included in the initial verification response 116 may be secured using various techniques such that an unauthorized user may be unable to determine the initial first authentication value V₀. Thus, even if an unauthorized user were to intercept every message sent between client computer system 102 and server system 108 during session verification, the unauthorized user would still be unable to determine the initial session chain value V₀ and, therefore, unable to determine subsequent updated session chain values.

In one embodiment, client computer system 102 may encrypt the initial first authentication value V₀, using a public key sent to the client computer system 102 by server system 108, to generate an encrypted first authentication value E₀. Client computer system 102 may, in various embodiments, include this encrypted first authentication value E₀ in the initial verification response 116 (rather than the unencrypted initial first authentication value V₀). In such an embodiment, server system 108 may decrypt the encrypted first authentication value E₀ using a private key associated with the session (that corresponds to the public key used to encrypt E₀) to recover the initial first authentication value V₀. In this embodiment, as there is no prior session chain value C′, the recovered initial first authentication value V₀ may be used as the initial session chain value C′₀. Hash determination module 306 may then generate an initial server authentication value H′₀, by calculating a hash of the initial session chain value C′₀, for use in verifying the session.

Further, in another embodiment, the initial first authentication value V₀ included in the initial verification response 116 may be secured by combining the initial first authentication value V₀ with a shared value (e.g., a shared string). For example, in one embodiment, client computer system 102 may first generate an original version of the initial first authentication value V₀ using authentication value generation module 202. Client computer system 102 may then combine this original version of the initial first authentication value V₀ with a shared value, such as the end user's a username, password, etc., to generate a modified first authentication value, which may be included in the initial verification response 116. In such an embodiment, server system 108 may extract, from the initial first authentication value based on the shared value, the original version of the initial first authentication value V₀. In this embodiment, as there is no prior session chain value C′, the original version of the initial first authentication value V₀ may be used as the initial session chain value C′₀. Hash determination module 306 may then generate an initial server authentication value H′₀, by calculating a hash of the initial session chain value C′₀, for use in verifying the session.

Note that, although described as being performed by server system 108, some or all of the user-authentication or session verification operations may be performed by a separate server system, in some embodiments. That is, in some embodiments, server system 108 may utilize a separate entity (e.g., a third-party service that performs operations discussed with reference to FIGS. 1 and 3) to perform session verification for sessions between the server system 108 and various end users of client computing devices.

### Example Methods

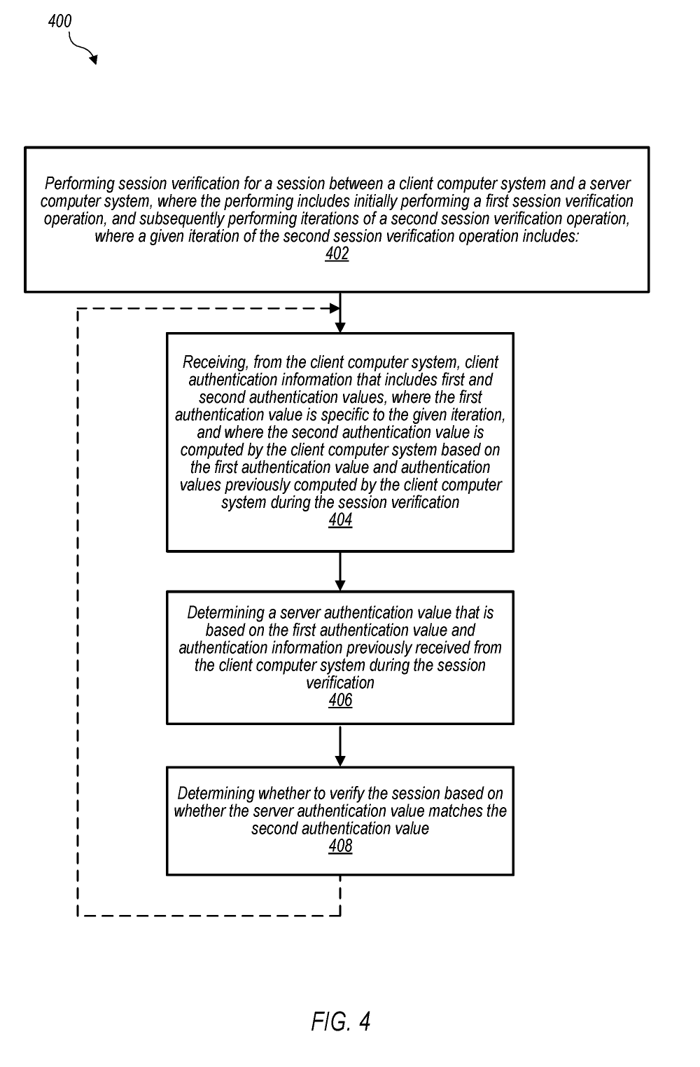

Turning now to FIG. 4, a flow diagram illustrating an example method 400 for verifying a session using updated session chain values is depicted, according to some embodiments. In various embodiments, method 400 may be performed, e.g., by server system 108 of FIG. 1, to verify a session between client computer system 102 and server system 108 using updated session chain values.

In FIG. 4, method 400 includes elements 402-408. While these elements are shown in a particular order for ease of understanding, other orders may be used. In various embodiments, some of the method elements may be performed concurrently, in a different order than shown, or may be omitted. Additional method elements may also be performed as desired. Element 402 includes performing session verification for a session between a client computer system and a server computer system, where the performing includes initially performing a first session verification operation, and subsequently performing iterations of a second session verification operation. For example, with reference to FIG. 1, once the authentication operations 112 have been performed and a session started between client computer system 102 and server system 108, server system 108 may initially perform a first session verification operation followed by iterations of a second session verification operation, as discussed above. In various embodiments, a given iteration of the session verification operation includes elements 404-408. Note that, as used herein, the term “given” is used to aid in discussion of a single iteration of a set of iterations, rather than treating the set of iterations as a whole. For example, for the set of iterations of the second session verification operation performed during a session, each iteration may, in at least some embodiments, include operations described with reference to elements 404-408 such that reference to a “given” iteration may be used to refer to any one of the instances in the set.

Method 400 then proceeds to element 404, which includes receiving, from the client computer system, client authentication information that includes first and second authentication values, where the first authentication value is specific to the given iteration, and where the second authentication value is computed by the client computer system based on the first authentication value and authentication values previously computed by the client computer system during the session verification. For example, as shown in FIG. 1, server system 108 may receive verification response 120 that includes first authentication value V₁ and second authentication value H₁. In some embodiments, first authentication value V₁ may be a random or pseudo-random value generated by authentication value generation module 202 for the given iteration of the second session verification operation. Further, in some embodiments, second authentication value H₁ may be a hash value generated based on an updated session chain value C₁, which in turn is based on first authentication value V₁ and a prior session chain value C₀.

Method 400 then proceeds to element 406, which includes determining a server authentication value that is based on the first authentication value and authentication information previously received from the client computer system during the session verification. For example, server system 108 may generate an updated session chain value C′₁ based on the first authentication value V₁ and a prior session chain value C′₀. Further, server system 108 may generate server authentication value H′₁ based on the updated session chain value C′₁.

Method 400 then proceeds to element 408, which includes determining whether to verify the session based on whether the server authentication value matches the second authentication value. For example, server system 108 may compare the second authentication value H₁ received from client computer system 102 with the server authentication value H′₁ generated by server system 108. Based on this comparison, server system 108 may determine whether to verify the session with client computer system 102. For example, in response to the second authentication value H₁ matching server authentication value H′₁, server system 108 may determine that the session is verified for that iteration. If, however, second authentication value H₁ does not match server authentication value H′₁, server system 108 may determine that the session is not verified, and server system 108 may take one or more corrective actions.

As shown in FIG. 4, elements 404-408 may be repeatedly performed, in at least some embodiments. For example, during the session between the client computer system 102 and server system 108, the iterations of the second session verification operations may be repeatedly performed after a particular time interval (e.g., 180 seconds) since a previous iteration. In other embodiments, iterations of the second session verification operations may be repeatedly performed each time (or every other time, every fifth time, etc.) that client computer system 102 sends a request to access a protected resource hosted by server system 108.

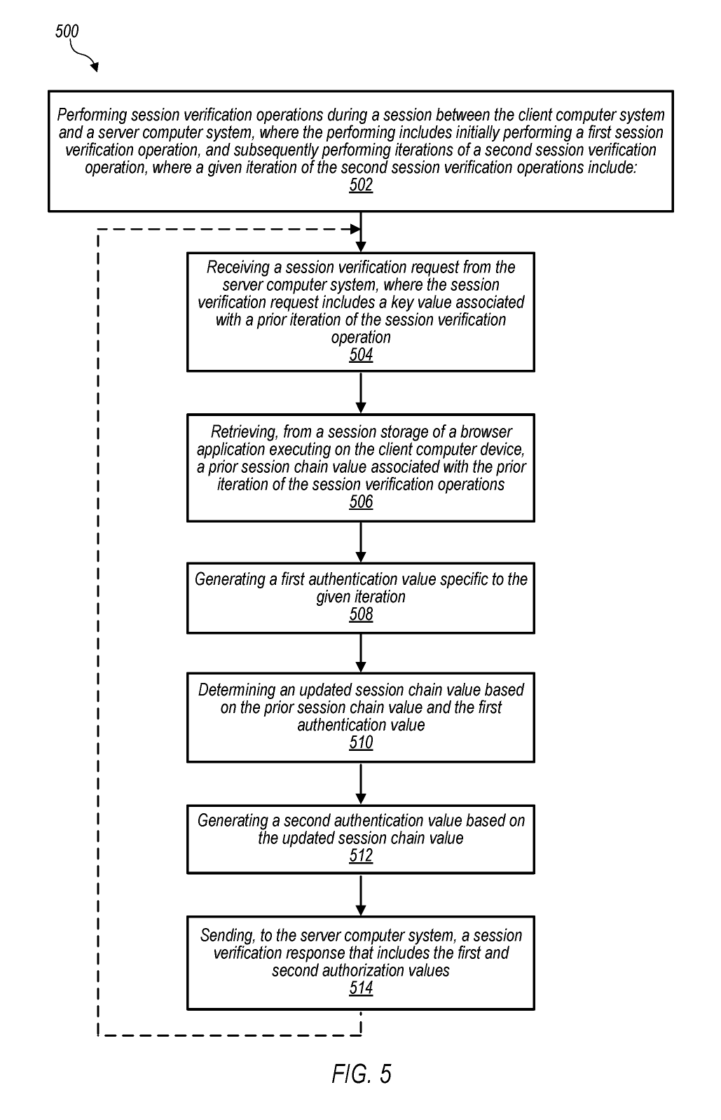

Referring now to FIG. 5, a flow diagram illustrating an example method 500 for verifying a session using updated session chain values is depicted, according to some embodiments. In various embodiments, method 500 may be performed, e.g., by client computer system 102 of FIG. 1. For example, in some embodiments, method 500 may be performed by client computer system 102 upon execution by browser program 104 of various script elements included in web pages sent by server system 108.

In FIG. 5, method 500 includes elements 502-514. While these elements are shown in a particular order for ease of understanding, other orders may be used. In various embodiments, some of the method elements may be performed concurrently, in a different order than shown, or may be omitted. Additional method elements may also be performed as desired. Element 502 includes performing session verification operations during a session between a client computer system and a server computer system, where the performing includes initially performing a first session verification operation, and subsequently performing iterations of a second session verification operation. For example, client computer system 102 may perform session verification operations during a session between client computer system 102 and server computer system 108. In various embodiments, a given iteration of the second session verification operations includes elements 504-514.

Method 500 then proceeds to element 504, which includes receiving a session verification request from the server computer system, where the session verification request includes a key value associated with a prior iteration of the session verification operation. For example, as shown in FIG. 1, client computer system 102 may receive session verification request 118 that includes key K₀. Method 500 then proceeds to element 506, which includes retrieving, from a session storage of a browser application executing on the client computer device, a prior session chain value associated with the prior iteration of the session verification operations. For example, in one embodiment, browser program 104 may retrieve, from session storage 106, session chain value C₀ that is associated with the first session verification operation.

Method 500 then proceeds to element 508, which includes generating a first authentication value specific to the given iteration. For example, in one embodiment, authentication value generation module 202 may generate a first authentication value V₁ for that iteration of the second session verification operation. Method 500 then proceeds to element 510, which includes determining an updated session chain value based on the prior session chain value and the first authentication value. For example, in one embodiment, session chain generation module 204 may generate updated session chain value C₁ based on first authentication value V₁ and the prior session chain value C₀.

Method 500 then proceeds to element 512, which includes generating a second authentication value based on the updated session chain value. For example, in one embodiment, hash determination module 206 may generate second authentication value H₁ based on updated session chain value C₁. Method 500 then proceeds to element 514, which includes sending, to the server computer system, a session verification response that includes the first and second authentication values. For example, in one embodiment, client computer system 102 may send verification response 120, including first authentication value V₁ and second authentication value H₁, to server system 108. Note that, as discussed above, the session chain value C₁ is not sent between the client computer system 102 and the server system 108.

As shown in FIG. 5, elements 504-514 may be repeatedly performed, in at least some embodiments. For example, as shown in FIG. 1, client computer system 102 and server system 108 may perform iterations of the second session verification operation during the course of a session. In one embodiment, for example, the iterations of the second session verification operations may be repeatedly performed after a particular time interval (e.g., 60 seconds) since a previous iteration.

### Example Computer System

Referring now to FIG. 6, a block diagram of an example computer system 600 is depicted, which may implement one or more computer systems, such as client computer system 102 or server system 108 of FIG. 1, according to various embodiments. Computer system 600 includes a processor subsystem 620 that is coupled to a system memory 640 and I/O interfaces(s) 660 via an interconnect 680 (e.g., a system bus). I/O interface(s) 660 is coupled to one or more I/O devices 670. Computer system 600 may be any of various types of devices, including, but not limited to, a server system, personal computer system, desktop computer, laptop or notebook computer, mainframe computer system, server computer system operating in a datacenter facility, tablet computer, handheld computer, workstation, network computer, etc. Although a single computer system 600 is shown in FIG. 6 for convenience, computer system 600 may also be implemented as two or more computer systems operating together.

Processor subsystem 620 may include one or more processors or processing units. In various embodiments of computer system 600, multiple instances of processor subsystem 620 may be coupled to interconnect 680. In various embodiments, processor subsystem 620 (or each processor unit within 620) may contain a cache or other form of on-board memory.

System memory 640 is usable to store program instructions executable by processor subsystem 620 to cause system 600 perform various operations described herein. System memory 640 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 600 is not limited to primary storage such as system memory 640. Rather, computer system 600 may also include other forms of storage such as cache memory in processor subsystem 620 and secondary storage on I/O devices 670 (e.g., a hard drive, storage array, etc.). In some embodiments, these other forms of storage may also store program instructions executable by processor subsystem 620.

I/O interfaces 660 may be any of various types of interfaces configured to couple to and communicate with other devices, according to various embodiments. In one embodiment, I/O interface 660 is a bridge chip (e.g., Southbridge) from a front-side to one or more back-side buses. I/O interfaces 660 may be coupled to one or more I/O devices 670 via one or more corresponding buses or other interfaces. Examples of I/O devices 670 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 670 includes a network interface device (e.g., configured to communicate over WiFi, Bluetooth, Ethernet, etc.), and computer system 600 is coupled to a network via the network interface device.

Although the embodiments disclosed herein are susceptible to various modifications and alternative forms, specific embodiments are shown by way of example in the figures and are described herein in detail. It should be understood, however, that figures and detailed description thereto are not intended to limit the scope of the claims to the particular forms disclosed. Instead, this application is intended to cover all modifications, equivalents and alternatives falling within the spirit and scope of the disclosure of the present application as defined by the appended claims. The headings used herein are for organizational purposes only and are not meant to be used to limit the scope of the description.

This disclosure includes references to “one embodiment,” “a particular embodiment,” “some embodiments,” “various embodiments,” “an embodiment,” etc. The appearances of these or similar phrases do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. When used in the claims, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the context clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used a power supply is not connected to it). Thus, an entity described or recited as “configured to” perform some task refers to something physical, such as a device, circuit, memory storing program instructions executable to implement the task, etc. This phrase is not used herein to refer to something

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

In this disclosure, various “modules” configured to perform designated functions are shown in the figures and described in detail above (e.g., authentication value generation module 202, session chain generation module 204, hash determination module 206, etc.). As used herein, the term “module” refers to circuitry configured to perform specified operations or to physical, non-transitory, computer-readable media that stores information (e.g., program instructions) that instructs other circuitry (e.g., a processor) to perform specified operations. Such circuitry may implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
performing, by a server computer system, session verification for a session between a client computer system and the server computer system, wherein the performing includes:
initially performing a first session verification operation; and
subsequently performing iterations of a second session verification operation, wherein a given iteration of the second session verification operation includes:
receiving, at the server computer system from the client computer system, client authentication information that includes first and second authentication values, wherein the first authentication value is specific to the given iteration, and wherein the second authentication value is computed by the client computer system based on the first authentication value and authentication values previously computed by the client computer system during the session verification;
determining, by the server computer system, a server authentication value that is based on the first authentication value and authentication information previously received from the client computer system during the session verification; and
determining whether to verify the session based on whether the server authentication value matches the second authentication value.

2. The method of claim 1, wherein the determining the server authentication value includes:
generating an updated session chain value for the given iteration of the second session verification operation; and
calculating a hash value based on the updated session chain value to generate the server authentication value.

3. The method of claim 2, wherein the generating the updated session chain value includes combining the first authentication value with a prior session chain value from an immediately prior iteration of the second session verification operation.

4. The method of claim 3, wherein the combining includes performing an exclusive or (XOR) operation between the first authentication value and the prior session chain value.

5. The method of claim 1, wherein the first session verification operation includes determining an initial server authentication value, including by:
decrypting an initial first authentication value using a private key associated with the session to generate an initial session chain value; and
calculating an initial hash value based on the initial session chain value to generate the initial server authentication value.

6. The method of claim 1, wherein the first session verification operation includes determining an initial server authentication value, including by:
extracting, from an initial first authentication value based on a shared value, an original version of the initial first authentication value; and
calculating an initial hash value based on the original version of the initial first authentication value to generate the initial server authentication value.

7. The method of claim 1, wherein, during the session between the client computer system and the server computer system, the iterations of the second session verification operation are repeatedly performed after a particular time interval since a previous iteration.

8. A non-transitory, computer-readable medium having instructions stored thereon that are executable by a server computer system to perform operations comprising:
performing session verification for a session between a client computer system and the server computer system, wherein the performing includes:
initially performing a first session verification operation; and
subsequently performing iterations of a second session verification operation, wherein a given iteration of the second session verification operation includes:
receiving, at the server computer system from the client computer system, client authentication information that includes first and second authentication values, wherein the first authentication value is specific to the given iteration, and wherein the second authentication value is computed by the client computer system based on the first authentication value and authentication values previously computed by the client computer system during the session verification;
determining, by the server computer system, a server authentication value that is based on the first authentication value and authentication information previously received from the client computer system during the session verification; and
determining whether to verify the session based on whether the server authentication value matches the second authentication value.

9. The non-transitory, computer-readable medium of claim 8, wherein the operations further comprise:
generating an updated session chain value for the given iteration of the second session verification operation; and
calculating a hash value based on the updated session chain value to generate the server authentication value.

10. The non-transitory, computer-readable medium of claim 9, wherein the generating the updated session chain value includes combining the first authentication value with a prior session chain value from an immediately previous iteration of the second session verification operation.

11. The non-transitory, computer-readable medium of claim 10, wherein the combining includes performing an exclusive or (XOR) operation between the first authentication value and the prior session chain value.

12. The non-transitory, computer-readable medium of claim 8, wherein the first session verification operation includes determining an initial server authentication value, including by:
decrypting an initial first authentication value using a private key associated with the session to generate an initial session chain value; and
calculating an initial hash value based on the initial session chain value to generate the initial server authentication value.

13. The non-transitory, computer-readable medium of claim 8, wherein the first session verification operation includes determining an initial server authentication value, including by:
extracting, from an initial first authentication value based on a shared value, an original version of the initial first authentication value; and
calculating an initial hash value based on the original version of the initial first authentication value to generate the initial server authentication value.

14. A method, comprising:
performing, by a client computer system, session verification operations during a session between the client computer system and a server computer system, wherein the performing includes:
initially performing a first session verification operation; and
subsequently performing iterations of a second session verification operation, wherein a given iteration of the second session verification operation include:
receiving, by the client computer system, a session verification request from the server computer system, wherein the session verification request includes a key value associated with a prior iteration of the session verification operations;
retrieving, from a session storage of a browser application executing on the client computer system, a prior session chain value associated with the prior iteration of the session verification operations;
generating a first authentication value specific to the given iteration;
determining an updated session chain value based on the prior session chain value and the first authentication value;
generating a second authentication value based on the updated session chain value; and
sending, to the server computer system, a session verification response that includes the first and second authentication values.

15. The method of claim 14, wherein the second authentication value is a hash value based on the updated session chain value; and wherein the session verification response does not include the updated session chain value.

16. The method of claim 14, wherein the determining the updated session chain value includes combining the first authentication value with the prior session chain value using an XOR operation.

17. The method of claim 14, wherein the given iteration of the session verification operations further include storing the updated session chain value in the session storage of the browser application.

18. The method of claim 14, wherein the first session verification operation includes encrypting an initial first authentication value, using a public key associated with the session, to generate an encrypted first authentication value; and wherein the encrypted first authentication value is included in an initial session verification response.

19. The method of claim 14, wherein the first session verification operation includes generating an initial first authentication value, including by:
generating an original version of the initial first authentication value; and
combining the original version of the initial first authentication value with a shared value to generate the initial first authentication value.

20. The method of claim 19, wherein the original version of the initial first authentication value is a random value generated by the client computer system for the first session verification operation; and wherein the session verification request is received in response sending, to the server computer system, a request to access a protected resource hosted by the server computer system.
